(19) United States
(12) Patent Application Publication
(10) Pub. No.: US 2026/0285163 A1
(43) Pub. Date: Sep. 24, 2026

(54) VEHICLE CONTROL METHOD, A VEHICLE CONTROL APPARATUS AND A VEHICLE SYSTEM HAVING THE SAME

(71) Applicants: HYUNDAI MOTOR COMPANY, Seoul (KR); KIA CORPORATION, Seoul (KR)

(72) Inventors: Sang Hyeok Mo, Hwaseong-si (KR); Jun Hyeong Jo, Hwaseong-si (KR)

(73) Assignees: HYUNDAI MOTOR COMPANY, Seoul (KR); KIA CORPORATION, Seoul (KR)

(21) Appl. No.: 19/310,303

(22) Filed: Aug. 26, 2025

(30) Foreign Application Priority Data
Mar. 24, 2025 (KR) 10-2025-0037283

(51) Int. Cl. B60L 7/18; B60L 15/20; B60L 50/60; G06T 7/70; G06V 20/58

(52) U.S. Cl. CPC B60L 7/18; B60L 15/20; B60L 50/60; G06T 7/70; G06V 20/582; B60L 2240/12; B60L 2240/421; B60L 2250/28; G06T 2207/30252

(57) ABSTRACT

A vehicle control method includes receiving traffic sign information detected in front of a vehicle; collecting vehicle driving information timing at a timing determined based on whether an accelerator pedal and a brake pedal of the vehicle are operated; determining a regenerative braking level based on the vehicle driving information; and controlling the vehicle based on the regenerative braking level.

### CROSS-REFERENCE TO RELATED APPLICATION(S)

This application claims the benefit of and priority to Korean Patent Application No. 10-2025-0037283 filed on Mar. 24, 2025 in the Korean Intellectual Property Office, the entire contents of which are incorporated herein by reference.

### TECHNICAL FIELD

The present disclosure relates to a vehicle control method, a vehicle control apparatus, and a vehicle including the same.

### BACKGROUND

A motor drive system for driving and power generation may be mounted in an eco-friendly vehicle, such as a hybrid vehicle, an electric vehicle, a fuel cell vehicle, or the like. When braking an eco-friendly vehicle, regenerative braking may be performed by operating a motor as a generator to convert the vehicle's kinetic energy into electric energy, in addition to using a conventional hydraulic friction brake.

However, a general regenerative braking mode may reduce smoothness of riding in the vehicle, may reduce a vehicle's coasting ability, and may affect feeling and responsiveness for braking of the vehicle. These characteristics of the regenerative braking may generally reduce user satisfaction for driving experience.

The subject matter described in this background section is intended to promote an understanding of the background of the disclosure and thus may include subject matter that is not already known to those of ordinary skill in the art.

### SUMMARY

An aspect of the present disclosure aims to provide a vehicle control method, a vehicle control apparatus, and a vehicle including the same, which may improve driving stability of a vehicle by adjusting regenerative braking of the vehicle according to traffic sign information detected through a front camera and may increase driving convenience by minimizing an operation of a brake pedal by a driver.

An aspect of the present disclosure aims to provide a vehicle control method, a vehicle control apparatus, and a vehicle including the same, which may improve driving comfort and control convenience by appropriately differentiating and applying the regenerative braking level based on a driving situation of the vehicle.

In order to achieve the above-mentioned purpose, the present disclosure provides a vehicle control method, a vehicle control apparatus, and a vehicle including the same, as follows.

The present disclosure, in an embodiment, provides a vehicle control method including: receiving traffic sign information detected in front of a vehicle. The method further includes collecting vehicle driving information at a timing determined based on whether an accelerator pedal or a brake pedal of the vehicle is operated. The method further includes determining a regenerative braking level based on the vehicle driving information. The method further includes controlling the vehicle based on the regenerative braking level.

The present disclosure, in an embodiment, provides, a vehicle control apparatus including a processor; and a storage medium configured to store instructions executable by the processor. The processor is configured, by executing the instructions, to receive traffic sign information from a front camera of the vehicle. The processor is further configured to collect vehicle driving information at a timing determined based on whether an accelerator pedal and a brake pedal of the vehicle are operated. The processor is further configured to determine a regenerative braking level based on the vehicle driving information. The processor is further configured to control the vehicle based on the regenerative braking level.

The present disclosure, in an embodiment, provides, a vehicle system including a motor; a battery; a sensing unit including at least one front camera; and a processor. The processor is configured to receive traffic sign information from the at least one front camera. The processor is further configured to collect vehicle driving information at a timing determined based on whether an accelerator pedal and a brake pedal of a vehicle are operated. The processor is further configured to determine a regenerative braking level based on the vehicle driving information. The processor is further configured to control the vehicle based on the regenerative braking level.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 illustrates a driving environment of a vehicle system according to an embodiment of the present disclosure.

FIG. 2 is a block diagram of a vehicle system according to an embodiment of the present disclosure.

FIG. 3 is a flow chart of a vehicle control method according to an embodiment of the present disclosure.

FIG. 4 is a flow chart of a vehicle control method according to another embodiment of the present disclosure.

FIG. 5A is a graph illustrating a vehicle control method according to an embodiment of the present disclosure.

FIG. 5B is a graph illustrating a vehicle control method according to an embodiment of the present disclosure.

FIG. 6 is a block diagram of a computing device that may fully or partially implement a vehicle control apparatus according to an embodiment of the present disclosure.

### DETAILED DESCRIPTION

Hereinafter, embodiments of the present disclosure are described with reference to the drawings. The following detailed description may be provided to help to understand a method, an apparatus, and/or a system described herein. However, this is only illustrative and the present disclosure is not limited thereto.

In describing embodiments of the present disclosure, when it is judged that a detailed description of a known technology related to the present disclosure is unnecessarily obscure the gist of the present disclosure, the detailed description has been omitted. In addition, the terms described below may be terms defined in consideration of their functions in the present disclosure and may be changed based on intention or custom of a user or an operator. Therefore, the definitions should be made based on contents throughout the present disclosure. The terms used in the present disclosure may be only used to describe embodiments and may not be intended to limit the present disclosure. A singular expression may include a plural expression unless the context clearly dictates otherwise. In the present application, terms such as “comprise,” “include,” “have,” and the like are intended to designate that a feature, a number, an operation, an operation, a component, a part, or a combination thereof described in the present disclosure exists, but it should be understood that existence or addition of one or more other features, numbers, operations, components, parts, or combinations thereof are excluded.

In addition, throughout the present disclosure, when a portion is said to be ‘connected’ to another portion, this may include not only a case in which it is ‘directly connected’ but also a case in which it is ‘indirectly connected’ to another element therebetween. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

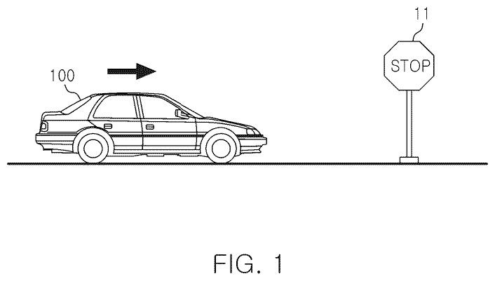

FIG. 1 illustrates a driving environment of a vehicle system according to an embodiment of the present disclosure. As illustrated in FIG. 1, a traffic sign 11 may be located above or on a side surface of a road on which a vehicle system 100 is driving.

The traffic sign 11 may be one of a stop sign indicating stop of a vehicle or a deceleration sign indicating deceleration of a vehicle according to a crosswalk, a child protection zone, a road type, or the like.

According to an embodiment of the present disclosure, a vehicle control method and a vehicle control apparatus for recognizing the traffic sign using a front camera, appropriately adjusting a regenerative braking level to improve driving stability of the vehicle, and increasing driving convenience by minimizing an operation of a brake pedal, may be provided.

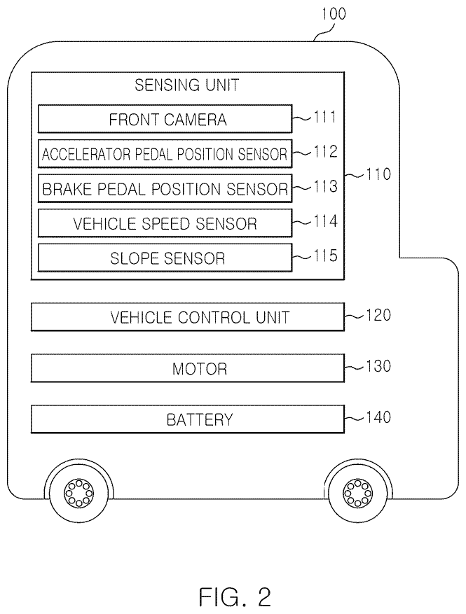

FIG. 2 is a block diagram of a vehicle system according to an embodiment of the present disclosure. Referring to FIG. 2, a vehicle system 100 may include a sensing unit 110, a vehicle control unit 120, a motor 130, and a battery 140.

The sensing unit 110 may include one or more sensors. The one or more sensors may be installed inside or outside the vehicle system 100 and may detect information related to the status or driving situation of the vehicle system 100.

The sensing unit 110 may include a front camera 111, an accelerator pedal position sensor (APS) 112, a brake pedal position sensor (BPS) 113, a vehicle speed sensor 114, and a slope sensor 115.

The front camera 111 may be installed on a front surface of the vehicle and may acquire front image data. For example, the front camera 111 may acquire front image data including a traffic sign located above or on a side surface of a road on which a vehicle is driving.

The accelerator pedal position sensor 112 may be linked to an operation of an accelerator pedal by a driver. An acceleration request signal of the vehicle may be input through the accelerator pedal position sensor 112.

The brake pedal position sensor 113 may be linked to an operation of a brake pedal by the driver. A deceleration request signal of the vehicle may be input through the brake pedal position sensor 113.

The vehicle speed sensor 114 may detect a driving speed of the vehicle.

The slope sensor 115 may detect an inclination of the vehicle or a gradient of a driving surface.

The sensing unit 110 may further include at least one of a wheel speed sensor detecting a speed of a wheel of the vehicle, a steering angle sensor (SAS) linked to an operation of a steering wheel, a temperature sensor detecting a temperature inside or outside the vehicle, an image sensor acquiring image data for an interior or an exterior of the vehicle, or a distance sensor measuring a distance from the vehicle to an obstacle located in one direction.

The vehicle control unit 120 may transmit and receive a signal with other components included in the vehicle system 100. The vehicle control unit 120 may generate a control signal for controlling other components of the vehicle system 100.

The vehicle control unit 120 may include a processor performing a vehicle control method according to an embodiment of the present disclosure.

The motor 130 may generate driving force for driving the vehicle. The motor 130 may supply driving force to a front wheel and a rear wheel of the vehicle, for example.

The battery 140 may include a secondary battery capable of charging or discharging electricity. The vehicle system 100 may be a hybrid vehicle or an electric vehicle driving the motor using power supplied from the battery 140.

In addition, the battery 140 may supply power to other components included in the vehicle system 100. For example, the battery 140 may supply power to and operate a display, an input module, a communication module, a sensor module, a memory, and a processor, included in the vehicle system 100.

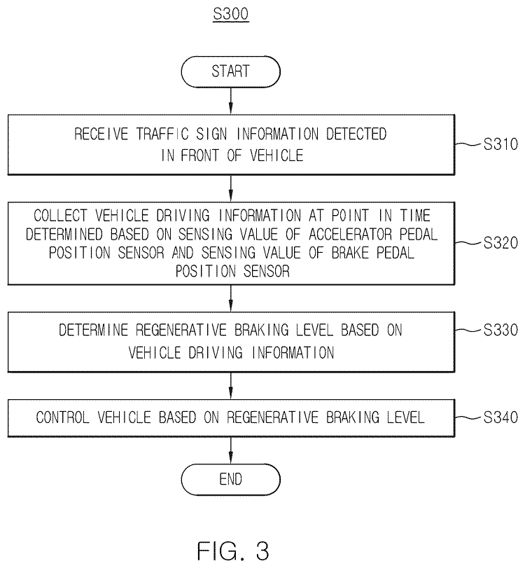

FIG. 3 is a flow chart of a vehicle control method according to an embodiment of the present disclosure. Referring to FIG. 3, a vehicle control method (S300) may include an operation (S310) of receiving traffic sign information detected in front of a vehicle, an operation (S320) of collecting vehicle driving information, an operation (S330) of determining a regenerative braking level based on the vehicle driving information, and an operation (S340) of controlling the vehicle based on the regenerative braking level.

In the operation (S310) of receiving traffic sign information detected in front of a vehicle, the traffic sign information may be collected using a front camera.

The traffic sign information may include information on a position and contents of a traffic sign detected by the front camera of the vehicle.

The operation (S320) of collecting vehicle driving information may include an operation of receiving a sensing value of an accelerator pedal position sensor of the vehicle; an operation of receiving a sensing value of a brake pedal position sensor of the vehicle. The operation (S320) of collecting vehicle driving information may further include an operation of collecting the vehicle driving information at a first timing at which both an accelerator pedal and a brake pedal are determined to be in an off state.

In an embodiment, the first timing may be a timing at which a driver is determined not to operate both the accelerator pedal and the brake pedal after a traffic sign is recognized through the front camera.

The operation of collecting the vehicle driving information at a first timing may determine the accelerator pedal of the vehicle as an off state, when the sensing value of the accelerator pedal position sensor is within a range corresponding to an idle state. The operation of collecting the vehicle driving information at a first timing may determine the brake pedal of the vehicle as an off state, when the sensing value of the brake pedal position sensor is within a range corresponding to the idle state.

The operation of collecting the vehicle driving information at a first timing may include an operation of collecting vehicle speed information at the first timing and may include an operation of collecting slope information at the first timing.

The operation (S330) of determining a regenerative braking level based on the vehicle driving information may include an operation of determining whether a vehicle speed at the first timing is equal to or greater than a preset first reference speed. The first reference speed may be set to, for example, 20 km/h.

In an embodiment, the vehicle control apparatus may be set to change the regenerative braking level when the vehicle speed at the first timing is equal to or greater than the preset first reference speed. The vehicle control apparatus may be set not to change the regenerative braking level when the vehicle speed at the first timing is less than the preset first reference speed.

The operation (S330) of determining a regenerative braking level based on the vehicle driving information may determine the regenerative braking level from a preset two-dimensional map, based on the vehicle speed information at the first timing and the slope information at the first timing.

The preset two-dimensional map may include information on the regenerative braking level mapped for a value of a vehicle speed and a value of a slope.

In an embodiment, the two-dimensional map may be set such that the regenerative braking level is determined strongly as the value of the vehicle speed increases. In addition, the two-dimensional map may be set such that the regenerative braking level is determined strongly as the value of the slope increases.

The operation (S330) of determining a regenerative braking level may determine the regenerative braking level further based on traffic sign information.

The operation (S340) of controlling the vehicle based on the regenerative braking level may control the vehicle such that regenerative braking is performed according to the regenerative braking level determined in S330.

In S340, the regenerative braking level of the vehicle may be set strongly or weakly based on vehicle driving information and traffic sign information.

In an embodiment of the present disclosure, the vehicle system may control regenerative braking and hydraulic braking of the vehicle based on traffic sign information collected through the front camera.

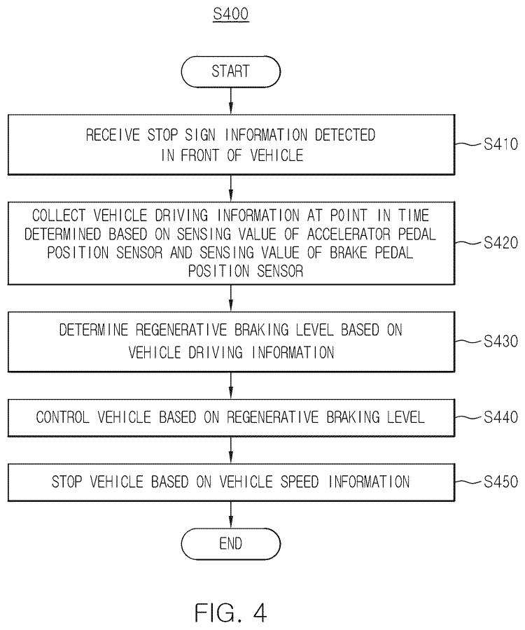

FIG. 4 is a flow chart of a vehicle control method according to another embodiment of the present disclosure. Referring to FIG. 4, a vehicle control method (S400) may include an operation (S410) of receiving stop sign information detected in front of a vehicle, an operation (S420) of collecting vehicle driving information, an operation (S430) of determining a regenerative braking level based on the vehicle driving information, an operation (S440) of controlling the vehicle based on the regenerative braking level, and an operation (S450) of stopping the vehicle based on vehicle speed information.

In the operation (S410) of receiving stop sign information detected in front of a vehicle, the stop sign information may be collected using a front camera.

The stop sign information may be obtained from image data acquired by the front camera of the vehicle.

The operation (S420) of collecting vehicle driving information may include an operation of receiving a sensing value of an accelerator pedal position sensor of the vehicle; an operation of receiving a sensing value of a brake pedal position sensor of the vehicle. The operation (S420) of collecting vehicle driving information may further include an operation of collecting the vehicle driving information at a first timing at which both an accelerator pedal and a brake pedal are determined to be in an off state.

In an embodiment, the first timing may be a timing at which a driver is determined not to operate both the accelerator pedal and the brake pedal after a stop sign is recognized through the front camera.

The operation of collecting the vehicle driving information at a first timing may determine the accelerator pedal of the vehicle as an off state, when the sensing value of the accelerator pedal position sensor is within a range of an idle state. The operation of collecting the vehicle driving information at a first timing may determine the brake pedal of the vehicle as an off state, when the sensing value of the brake pedal position sensor is within a range of an idle state.

The vehicle driving information at a first timing may include vehicle speed information at the first timing, and slope information at the first timing.

The operation (S430) of determining a regenerative braking level based on the vehicle driving information may include an operation of determining whether a vehicle speed at the first timing is equal to or greater than a preset first reference speed.

In an embodiment, the vehicle control apparatus may be set to change the regenerative braking level when the vehicle speed at the first timing is equal to or greater than the preset first reference speed. The vehicle control apparatus may be set not to change the regenerative braking level when the vehicle speed at the first timing is less than the preset first reference speed.

The operation (S430) of determining a regenerative braking level based on the vehicle driving information may determine the regenerative braking level from a preset two-dimensional map, based on the vehicle speed information at the first timing and the slope information at the first timing.

The preset two-dimensional map may include information on the regenerative braking level mapped for a value of a vehicle speed and a value of a slope.

In an embodiment, the two-dimensional map may be set such that the regenerative braking level is determined strongly as the value of the vehicle speed increases. In addition, the two-dimensional map may be set such that the regenerative braking level is determined strongly as the value of the slope increases.

The operation (S440) of controlling the vehicle based on the regenerative braking level may control the vehicle such that regenerative braking is performed according to the regenerative braking level determined in S430.

The operation (S450) of stopping the vehicle based on vehicle speed information may include an operation of determining whether a real-time vehicle speed of the vehicle has decreased equal to or less than a preset second reference speed. The operation (S450) of stopping the vehicle based on vehicle speed information may further include an operation of controlling braking of the vehicle using a motor and a braking mechanism of the vehicle, when the real-time vehicle speed decreases equal to or less than the second reference speed.

In an embodiment, the second reference speed may be set to have a value less than the first reference speed. The second reference speed may be set to, for example, 3 km/h.

The operation of controlling braking of the vehicle may include an operation of reducing a motor RPM value of the vehicle to 0 and may include an operation of performing hydraulic braking by the braking mechanism.

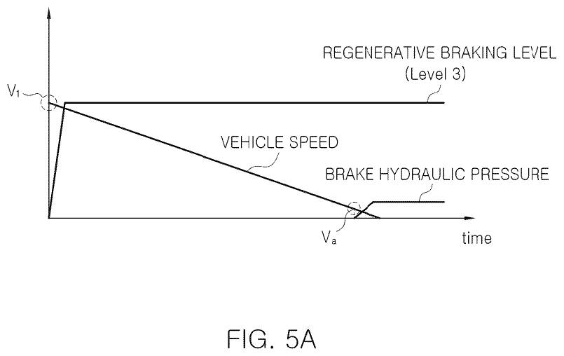

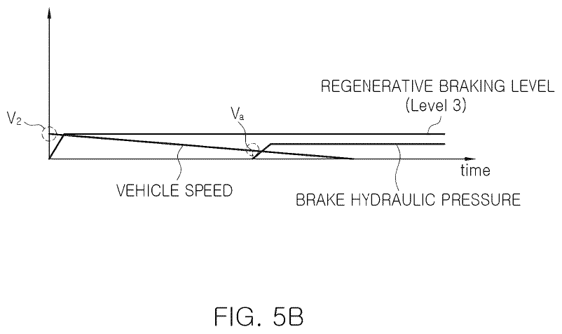

FIGS. 5A and 5B are graphs illustrating a vehicle control method according to an embodiment of the present disclosure and illustrate a vehicle speed, a regenerative braking level, and a brake hydraulic pressure.

In FIG. 5A, V₁ represents a vehicle speed at a first timing at which both an accelerator pedal and a brake pedal are determined to be in an off state. According to FIG. 5A, the vehicle speed may be gradually reduced as a vehicle is controlled according to a regenerative braking level (Level 3) determined based on vehicle driving information. When the vehicle speed is reduced equal to or less than a second reference speed (Vₐ), a vehicle may be decelerated/stopped by a brake hydraulic pressure.

In FIG. 5B, V₂ represents a vehicle speed at a first timing at which both an accelerator pedal and a brake pedal are determined to be in an off state. V₂ may have a smaller value than V₁. According to FIG. 5B, a regenerative braking level may be determined weakly, as compared to FIG. 5A.

In FIG. 5B, the vehicle speed may be gradually reduced by controlling a vehicle according to a regenerative braking level (Level 1) determined based on vehicle driving information. Similarly, when the vehicle speed is reduced equal to or less than a second reference speed (Vₐ), the vehicle may be decelerated/stopped by a brake hydraulic pressure.

According to an embodiment of the present disclosure, the vehicle may be controlled based on additional allowable information of rear wheel regenerative braking, a total regenerative braking amount may increase, and as a result, the effect of improving fuel efficiency may be achieved.

In addition, a rear wheel regenerative braking amount may increase to effectuate effects of preventing overheating of a rear wheel brake system and improving stability of the vehicle.

According to another embodiment of the present disclosure, when the traffic sign detected by the front camera is a deceleration sign, the vehicle control method may further include an operation of decelerating the vehicle based on real-time vehicle speed information of the vehicle.

The operation of decelerating the vehicle based on real-time vehicle speed information of the vehicle may perform regenerative braking and hydraulic braking to decelerate the vehicle speed onto a level according to the deceleration sign detected by the front camera, in a similar manner to S400.

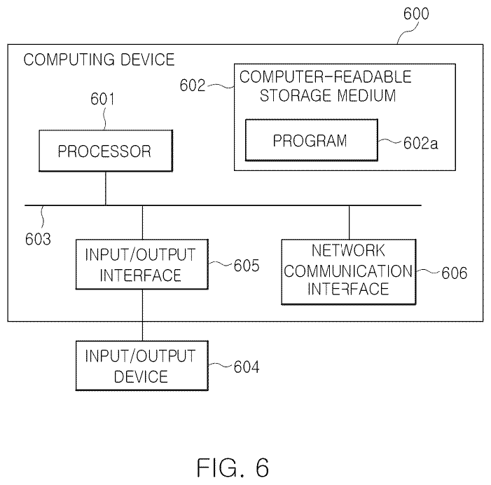

FIG. 6 is a block diagram of a computing device 600 that may fully or partially implement a vehicle system 100 according to an embodiment of the present disclosure, which may include all or portion of the vehicle system 100 illustrated in FIG. 2.

As illustrated in FIG. 6, a computing device 600 may include at least one processor 601, a computer-readable storage medium 602, and a communication bus 603.

The processor 601 may cause the computing device 600 to operate according to the embodiments mentioned above. For example, the processor 601 may execute one or more programs stored in the computer-readable storage medium 602. The one or more programs may include one or more computer-executable instructions, which, when executed by the processor 601, may be configured to cause the computing device 600 to perform operations according to an embodiment.

The computer-readable storage medium 602 may be configured to store a computer-executable instruction or a program code, program data, and/or other suitable forms of information. A program 602a stored on the computer-readable storage medium 602 may include a set of instructions executable by the processor 601. In an embodiment, the computer-readable storage medium 602 may be a memory (volatile memory, such as a random access memory, a non-volatile memory, or a suitable combination thereof), one or more magnetic disk storage devices, optical disk storage devices, flash memory devices, or any other form of storage medium accessible by the computing device 600 and capable of storing desired information, or a suitable combination thereof.

The communication bus 603 may interconnect the processor 601 and various other components of the computing device 600 including the computer-readable storage medium 602.

The computing device 600 may also include at least one input/output interface 605 providing an interface for at least one input/output device 604 and may also include at least one network communication interface 606. The input/output interfaces 605 and the network communication interfaces 606 may be connected to the communication bus 603.

The network communication interface 606 may be an interface for communication within a vehicle or for communication between the vehicle and other devices outside the vehicle. The network communication interface 606 may include, for example, a controller area network (CAN), a media oriented systems transport (MOST) network, a local interconnect network (LIN), and/or an X-by-wire (Flexray), Wi-Fi, Bluetooth, NFC, RFID, or the like. The network may be a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), or another cellular network.

The input/output device 604 may be connected to other components of the computing device 600 via the input/output interface 605. Examples of the input/output devices 604 may include input devices, such as a pointing device (such as a mouse, a trackpad, or the like), a keyboard, a touch input device (such as a touchpad, a touchscreen, or the like), a voice or sound input device, various types of sensor devices and/or photographing devices, and/or output devices such as a display device, a printer, a speaker, and/or a network card. The examples of the input/output device 604 may be included in the computing device 600 as a component constituting the computing device 600 or may be connected to the computing device 600 as a separate device distinct from the computing device 600.

An embodiment of the present disclosure may include a program for performing methods described in the present disclosure on a computer, and a computer-readable recording medium including the program. The computer-readable recording medium may include a program command, a local data file, a local data structure, or the like alone or in combination. The medium may be those designed and configured specifically for the present disclosure or may be those commonly available in the field of computer software. Examples of the computer-readable recording medium may include magnetic media, such as a hard disk, a floppy disk, and a magnetic tape, optical recording media such as a CD-ROM and a DVD, and hardware devices specifically configured to store and execute a program command such as a ROM, a RAM, a flash memory, or the like. Examples of the program may include not only machine language codes such as those generated by a compiler but also high-level language codes that may be executed by a computer using an interpreter or the like.

The present disclosure may provide a vehicle control method, a vehicle control apparatus, and a vehicle including the same, which may improve driving stability of a vehicle by adjusting regenerative braking of the vehicle according to traffic sign information detected through a front camera, and may increase driving convenience by minimizing an operation of a brake pedal by a driver.

The present disclosure may provide a vehicle control method, a vehicle control apparatus, and a vehicle including the same, which may improve comfortable driving feeling and control convenience of a driver by appropriately differentiating and applying the regenerative braking level in conformity with driving situation of a vehicle.

While example embodiments have been shown and described above, it should be apparent to those having ordinary skill in the art that modifications and variations could be made without departing from the scope of the present disclosure as defined by the appended claims.

What is claimed is:

1. A vehicle control method comprising:
receiving traffic sign information detected in front of a vehicle;
collecting vehicle driving information at a timing determined based on whether an accelerator pedal or a brake pedal of the vehicle is operated;
determining a regenerative braking level based on the vehicle driving information; and
controlling the vehicle based on the regenerative braking level.

2. The vehicle control method of claim 1, wherein collecting the vehicle driving information includes:
receiving a sensing value from an accelerator pedal position sensor of the vehicle;
receiving a sensing value from a brake pedal position sensor of the vehicle; and
collecting the vehicle driving information at a first timing at which both the accelerator pedal and the brake pedal are determined to be in an off state.

3. The vehicle control method of claim 2, wherein collecting the vehicle driving information at the first timing includes:
determining that the accelerator pedal of the vehicle is in the off state, when the sensing value of the accelerator pedal position sensor is within a range corresponding to an idle state; and
determining that the brake pedal of the vehicle is in the off state, when the sensing value of the brake pedal position sensor is within a range corresponding to the idle state.

4. The vehicle control method of claim 2, wherein collecting the vehicle driving information at the first timing includes:
collecting vehicle speed information at the first timing; and
collecting slope information at the first timing.

5. The vehicle control method of claim 4, wherein determining the regenerative braking level includes:
determining whether a vehicle speed at the first timing is equal to or greater than a preset first reference speed.

6. The vehicle control method of claim 4, wherein determining the regenerative braking level includes determining the regenerative braking level from a preset two-dimensional map, based on the vehicle speed information at the first timing and the slope information at the first timing, and
wherein the preset two-dimensional map includes information on the regenerative braking level mapped for a value of a vehicle speed and a value of a slope.

7. The vehicle control method of claim 2, wherein the traffic sign information includes information on a position and contents of a traffic sign detected by a front camera of the vehicle, and
wherein determining the regenerative braking level includes determining the regenerative braking level further based on the traffic sign information.

8. The vehicle control method of claim 7, further including:
stopping the vehicle based on real-time vehicle speed information of the vehicle, when the traffic sign is a stop sign.

9. The vehicle control method of claim 8, wherein stopping the vehicle includes:
determining whether a real-time vehicle speed of the vehicle has decreased equal to or less than a preset second reference speed; and
controlling braking of the vehicle using a motor and a braking mechanism of the vehicle, when the real-time vehicle speed decreases equal to or less than the preset second reference speed.

10. The vehicle control method of claim 9, wherein controlling braking of the vehicle includes:
reducing a motor RPM value of the vehicle to 0; and
performing hydraulic braking by the braking mechanism.

11. The vehicle control method of claim 7, further including:
decelerating the vehicle based on real-time vehicle speed information of the vehicle, when the traffic sign is a deceleration sign.

12. A vehicle control apparatus comprising:
a processor; and
a storage medium configured to store instructions executable by the processor,
wherein the processor is configured, by executing the instructions, to:
receive traffic sign information from a front camera of a vehicle;
collect vehicle driving information timing at a timing determined based on whether an accelerator pedal or a brake pedal of the vehicle is operated;
determine a regenerative braking level based on the vehicle driving information; and
control the vehicle based on the regenerative braking level.

13. The vehicle control apparatus of claim 12, wherein the processor is further configured to:
receive an accelerator pedal position sensing value from an accelerator pedal position sensor of the vehicle;
receive a brake pedal position sensing value from a brake pedal position sensor of the vehicle; and
collect the vehicle driving information at a first timing at which both the accelerator pedal and the brake pedal are determined to be in an off state.

14. The vehicle control apparatus of claim 13, wherein the processor is further configured to:
collect vehicle speed information at the first timing from a vehicle speed sensor of the vehicle; and
collect slope information at the first timing from a slope sensor of the vehicle.

15. The vehicle control apparatus of claim 14, wherein the processor is further configured to determine whether a vehicle speed at the first timing is equal to or greater than a preset first reference speed.

16. The vehicle control apparatus of claim 14, wherein the processor is further configured to determine the regenerative braking level from a preset two-dimensional map, based on the vehicle speed information at the first timing and the slope information at the first timing, and
wherein the preset two-dimensional map includes information on the regenerative braking level mapped for a value of a vehicle speed and a value of a slope.

17. The vehicle control apparatus of claim 13, wherein the traffic sign information includes information on a position and contents of a traffic sign detected by the front camera of the vehicle, and
wherein the processor is further configured to determine the regenerative braking level further based on the traffic sign information.

18. The vehicle control apparatus of claim 17, wherein the processor is further configured to stop the vehicle based on real-time vehicle speed information of the vehicle, when the traffic sign is a stop sign.

19. The vehicle control apparatus of claim 17, wherein the processor is further configured to:
determine whether a real-time vehicle speed of the vehicle has decreased equal to or less than a preset second reference speed, and
control braking of the vehicle using a motor and a braking mechanism of the vehicle, when the real-time vehicle speed decreases equal to or less than the preset second reference speed.

20. A vehicle system comprising:
a motor;
a battery;
a sensing unit including at least one front camera; and
a processor configure to:
receive traffic sign information from the at least one front camera;
collect vehicle driving information timing at a timing determined based on whether an accelerator pedal or a brake pedal of a vehicle is operated;
determine a regenerative braking level based on the vehicle driving information; and
control the vehicle based on the regenerative braking level.
